(19) United States
(12) Patent Application Publication
(10) Pub. No.: US 2020/0082398 A1
(43) Pub. Date: Mar. 12, 2020

(54) Proof-of-Devotion Blockchain Consensus Algorithm

(71) Applicant: Nebulas IO Limited, Road Town (VG)

(72) Inventor: Yiji Xu, Beijing (CN)

(21) Appl. No.: 16/125,512

(22) Filed: Sep. 7, 2018

(51) Int. Cl. G06Q 20/40; G06Q 20/06

(52) U.S. Cl. CPC G06Q 20/401; H04L 9/0643; G06Q 20/065

(57) ABSTRACT

Methods, systems, and apparatus, including computer programs encoded on computer storage media, for implementing a consensus algorithm on a blockchain, including: ranking computing nodes according to a metric; designating a number of the top-ranked computing nodes as validator nodes; selecting a proposer node; causing the proposer node to create a proposed block; causing each validator node to participate in a first round of voting on the proposed block after depositing a first amount of digital currency; in response to at least two-thirds of the validator nodes voting approval: distributing to each approving validator node a second amount of digital currency; causing the validator nodes to participate in a second round of voting on the proposed block; in response to at least two-thirds of the validator nodes voted approval: distributing to each approving validator node a third amount of digital currency; and adding the proposed block to the blockchain.

### BACKGROUND

A distributed ledger system is a decentralized data storage system with data replicated and synced across multiple computing nodes. A blockchain is a continuously growing list of data records linked and secured using cryptographic technology. A blockchain can be managed by a distributed ledger system, i.e., a blockchain network, with each computing node in the distributed ledger system adhering to a blockchain protocol for inter-node communication and new blocks validation.

A blockchain network decentralizes data storage as every computing node independently maintains an updated copy of the blockchain. Each computing node of the blockchain network independently validates new blocks to be appended to the blockchain. The computing nodes then collectively decide to append the new block using a consensus algorithm specified in the blockchain protocol.

### SUMMARY

This specification describes a particular implementation of a consensus algorithm for a blockchain network. These technologies generally involve using the consensus algorithm to coordinate computer nodes to manage a blockchain in the blockchain network. The techniques can further include: implementing a consensus process among a plurality of computing nodes in a blockchain network to add a block to a blockchain, wherein each computing node independently maintains a copy of a blockchain and communicates with other computing nodes according to a blockchain protocol, wherein implementing the consensus process comprises: ranking the computing nodes according to a metric in a past time period; designating a number of the top-ranked computing nodes as validator nodes; selecting a validator node as a proposer node using a random process, wherein each validator node has a probability of being selected as the proposer node; causing the proposer node to create a proposed block, wherein the proposed block comprises one or more transactions occurred on the blockchain; causing each validator node to participate in a first round of voting on the proposed block, wherein each validator node deposits a first amount of digital currency before participating, and wherein each validator node votes an approval or a rejection of the proposed block; in response to at least two-thirds of the validator nodes voting approval: distributing to each validator node that voted approval a second amount of digital currency; causing the validator nodes to participate in a second round of voting on the proposed block; in response to at least two-thirds of the validator nodes voted approval in the second round of voting: distributing to each validator node that voted approval a third amount of digital currency; and adding the proposed block to the blockchain.

Particular embodiments of the subject matter described in this specification can be implemented so as to realize one or more of the following advantages. Using a proof-of-devotion consensus algorithm incentivizes computers nodes in a blockchain network to truthfully validate transactions and update the blockchain. The proof-of-devotion consensus algorithm achieves this goal without requiring each computer node to spend a large amount of computer resources such as required by the proof-of-work consensus algorithm or hold a large amount of tokens for validating the transactions such as required by the proof-of-stake consensus algorithm. As a result, the proof-of-devotion consensus algorithm efficiently safeguards against attacks that attempt to append false information to the blockchain, and prevents computing nodes with large stakes in the blockchain to monopolize the blockchain ecocsystem.

The details of one or more embodiments of the subject matter of this specification are set forth in the accompanying drawing and description below. Other features, aspects, and advantages of the subject matter will become apparent from the description, the drawings, and the claims.

### BRIEF DESCRIPTION OF THE DRAWINGS

FIG. 1 is a schematic depiction of an example blockchain.

FIG. 2 is a schematic depiction of an example distributed ledger system.

FIG. 3 is a flowchart of an example process for implementing a proof-of-devotion consensus algorithm in a blockchain network.

Specific embodiments of the invention will now be described in detail with reference to the accompanying figures. Like elements in the various figures are denoted by like reference numerals for consistency.

### DETAILED DESCRIPTION

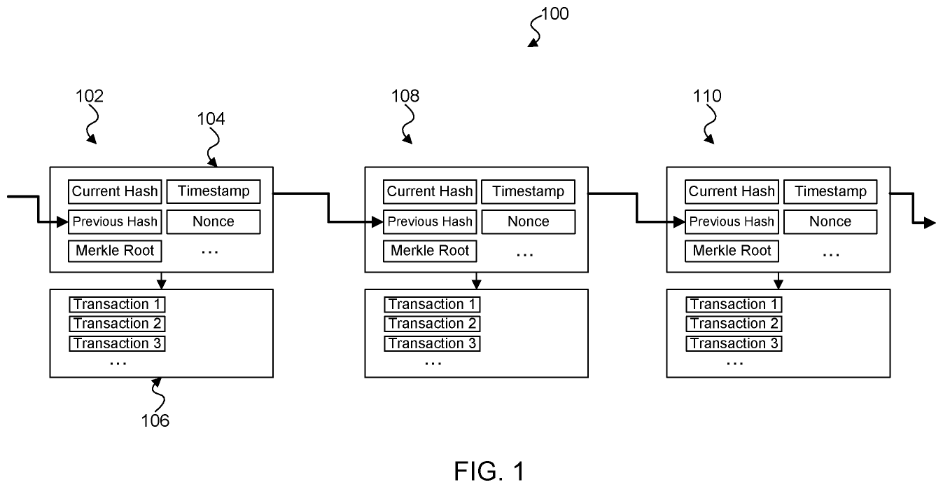

FIG. 1 is a schematic depiction of an example blockchain 100.

A blockchain is a linked list of blocks. Each block is a container data structure including at least (1) a block header and (2) a transaction list. For example, the blockchain 100 includes three example blocks, a block 102, a block 108, and a block 110 linked to each other.

A block header, e.g., the block header 104 for the block 102, includes metadata describing key aspects of the corresponding block. Example block header metadata include current hash, timestamp, previous hash, nonce, Merkle root, etc. Each of these metadata can be represented as a string value. For example, a block header can be represented by Table 1:

TABLE 1

| | |
|---|---|
| Current hash | “000000000000000000448b43be29890ca780b2b21e2e2a |
| | 0e53e04269d135abc8” |
| Previous hash | “0000000000000000002e22f7b842d8ec98d67e5ae |
| | 5041e263e3be7e3cea9bbb6” |
| Timestamp | “2018-04-30 19:02:08” |
| Nonce | “2069396004” |
| Merkle Root | “bcd5048e2c5a9960fb285dde4693a3ba7830ea69b8cf |
| | 9876214d31cd321f1dac” |

A transaction list, e.g., the transaction list 106 for the block 102, includes a list of transactions that occurred in a distributed ledger system, i.e., a peer-to-peer blockchain network that implements the blockchain. Each transaction in a transaction list occurred between the current timestamp and the time when the previous block was appended to the blockchain. An example transaction happens when one computing node, e.g., a transaction node, in the blockchain network, sends data, such as digital currency supported by the blockchain, to another computing node in the blockchain network. Another example transaction can include the distribution of digital currency to mining nodes by the blockchain network's consensus. Another example transaction can include a change of state of the current blockchain by the execution of a smart contract.

Each transaction can be described by (1) a sender address in the blockchain network, (2) a receiver address in the blockchain network, (3) transferred data, (4) a timestamp of the transaction, and (5) a unique transaction ID. Each of these fields can be represented as a string value. For example, a transaction can be represented by Table 2:

TABLE 2

| | |
|---|---|
| Sender Address | “134Qu1v9KenipLUCnZpC95GrBXh7S6vWog” |
| Receiver Address | “1FC6uZgnctM1BbVoQYZLCcN6o4KrgQZowE” |
| Timestamp | “2018-05-01 05:26:37” |
| Data | “0.6183096 BTC” |
| Transaction ID | “559dc5d4b58371da04c3719819e869a3b70bc3361 |
| | 45167d8bf662a480fece9bb” |

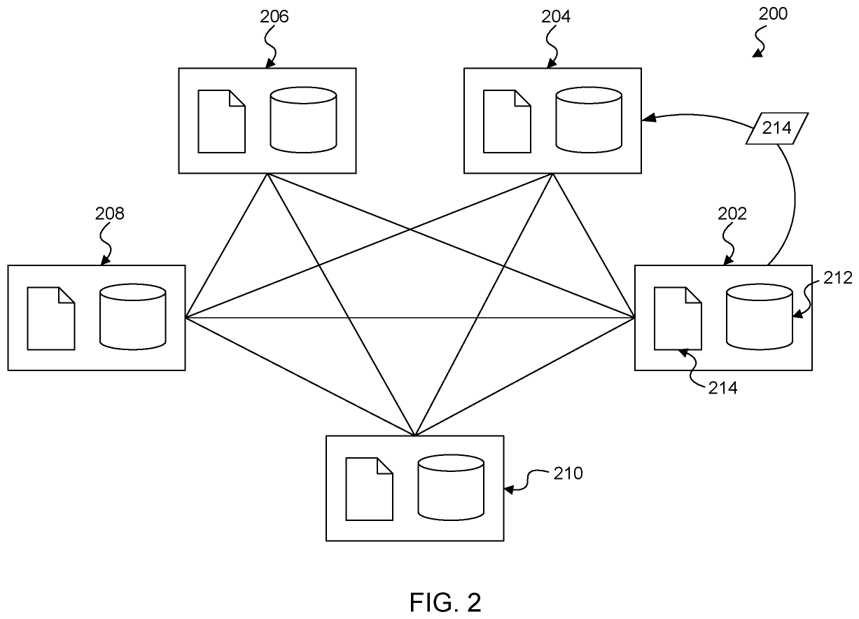

Each transaction will be broadcast to and validated in the blockchain network using a process called mining. Mining will be explained in more details below with reference to FIG. 2.

Current hash is a unique digital identifier of the current block. A hash is a cryptographic digital signature generated by feeding some selected data into a cryptographic hash function. A cryptographic hash function is a special class of hash functions that map data of arbitrary size to a bit string of a fixed size. For example, the cryptographic hash function used in table 1 has an output of a 32-bit string value. A cryptographic hash function useful for a blockchain is typically required to have five main properties:

1. It is deterministic so that the same data will result in the same hash.

2. It is quick to compute.

3. It is infeasible to recreate the data from its hash except by trying all possible messages.

4. A small change in the data will change the hash extensively.

5. It is infeasible to find two different data with the same hash value.

An example cryptographic hash function is the SHA-256 algorithm, which is used by the Bitcoin blockchain network. Other example cryptographic hash functions include BLAKE, BLAKE2, KECCAK-256, CryptoNight, etc.

Current hash is calculated by feeding block data, e.g., string values in the block header and the transaction list, to a cryptographic hash function specified in the blockchain protocol. Given that each block has unique block data and that it is infeasible to find two different data with the same hash value (property 5 mentioned above), current hash is unique for every block.

Previous hash is a hash pointer which points to the previous block. Previous hash has value equivalent to current hash of the previous block. As a result, except for the very first block, each block is connected to another block (the first block, or the “genesis block,” is generated automatically by the blockchain protocol). This design causes data on a blockchain to be immutable. For example, if a hacker wishes to change data in one block, data in all blocks must be changed since every block contains a bit of hashed information from another block, and a small change in the data will change the hash extensively.

Timestamp identifies the time when the current block was appended to the blockchain. Computing nodes can reference a dedicated time-reporting server to record consistent timestamp across the blockchain network.

Nonce is an arbitrary random value that is used in the cryptographic hash function to control the hash output. In order to add a new block to a blockchain, a special type of computing node “mining node” randomly chooses a nonce value and repeatedly hashes the block data including the chosen nonce till the hash output satisfies a specified condition. For example, the condition for adding a new block shown in table 1 is that the hash output (current hash) must have eighteen leading “0s.” Details on the process of adding a block to a blockchain are described below with reference to FIG. 2.

Merkle root is the top hash value produced by feeding data in a transaction list into a Merkle tree. A Merkle tree is a binary tree in which every leaf node is a hash of a data block and every non-leaf node is a hash of its two child nodes. Merkle root uniquely identifies the list of transactions associated with each block.

In some implementations, a reward is given to the mining node which first discovered a nonce to satisfy the specified condition for appending blocks. For example, the reward can be some digital currency specified by the blockchain. This incentives users to participate as mining nodes in the blockchain network to spend computing resources to compete in the so-called mining process described below. Each mining node maintains a copy of the blockchain locally, and communicates with other mining nodes to broadcast and validate new transactions.

FIG. 2 is a schematic depiction of an example distributed ledger system.

A distributed ledger system is a decentralized data storage system with data replicated and synced across multiple computing nodes. For example, a distributed ledger system can be implemented as a blockchain network. A blockchain network is a network of computing nodes set to maintain a blockchain, e.g., the blockchain 100 of FIG. 1, according to a specified blockchain protocol. For example, FIG. 2 shows a blockchain network 200 including five computing nodes 202, 204, 206, 208, and 210. Each computing node is independent from and connected to every other node. Computing nodes can assume different functions such as mining nodes, transaction nodes, decentralized applications, etc.

Each computing node includes a runtime that executes a specified blockchain protocol, e.g., a protocol 214 in the computing node 202. The blockchain protocol specifies rules including the conditions for allowing a mining node to add a new block to the blockchain, the frequency of adding new blocks, the type of data included in a block, or the amount of rewards to be distributed for appending the blockchain, etc.

Each computing node also includes a data storage area, e.g., a data storage area 212 of the computing node 202, for storing current information of the blockchain.

In some implementations, the blockchain network comprises one or more transaction nodes. Transaction nodes are a type of computing nodes in the blockchain network that do not implement the full blockchain protocol. For example, a transaction node does not spend computing resource to validate other transactions, but rely on mining nodes for such a task. A transaction node functions exclusively to send and receive data in the blockchain network with other computing nodes.

A transaction in the blockchain network is initiated when a transfer of data occurs. For example, the blockchain maintained in the blockchain network 200 can be a record of digital currency transactions among computing nodes. Each of the computing nodes 202, 204, 206, 208 and 210 can act as a transaction node and/or a mining node. That is to say, each of the computing nodes in FIG. 2 can both send and receive data, and validate new blocks to the blockchain. The computing node 202 can initiate a transaction 214 by sending some amount of digital currency to the computing node 204.

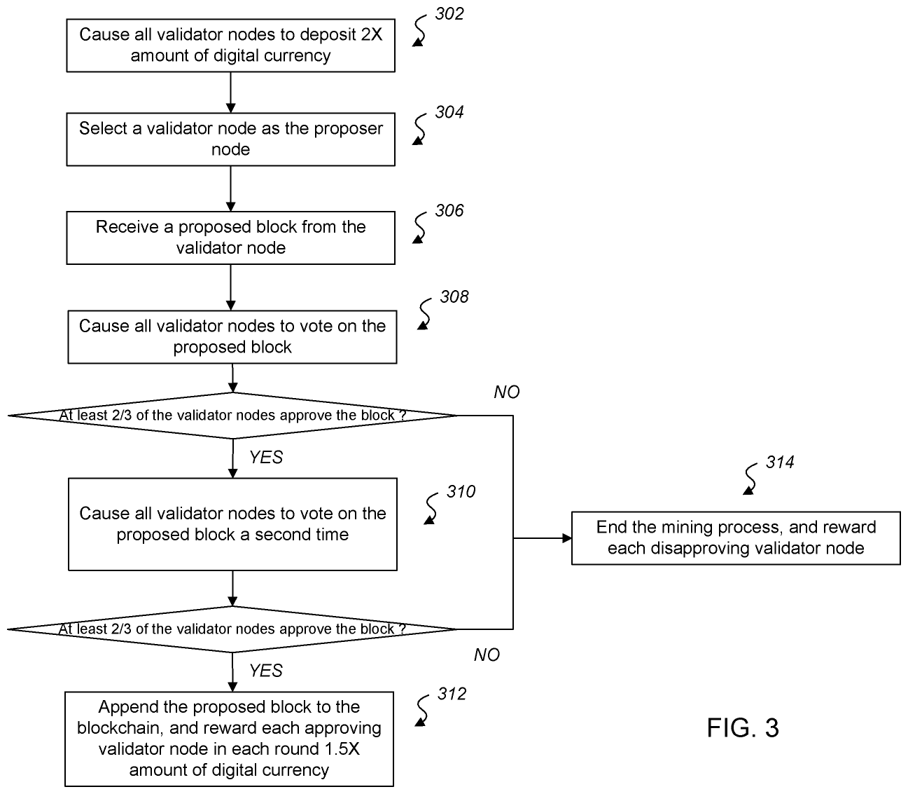

To have the blockchain record the transaction 214, the computing node 202 broadcasts this transaction to every other computing node in the blockchain network 200. Another computing node, e.g., the computing node 210, receives the transaction and performs two different tasks. First, the computing node 210 will verify that the transaction 214 is a valid transaction. For example, the computing node 210 can look into records in the existing blockchain to verify that the computing node 202 has the sufficient amount of digital currency to transfer to the computing node 204. Next, the computing node 210 participates in a mining process in an attempt to become one of the nodes that receive the authority to add this transaction to the blockchain, i.e., a validator node. For example, the mining process is administered according to a proof-of-devotion consensus algorithm described in FIG. 3 and the related description.

In some implementations, to become a validator node to participate in the mining process, a computing node spends computing resource to search for a special string (nonce) that causes the hash output of the block (current hash) to satisfy a specified condition. If a computing node is the first node to find the appropriate nonce, then the computing node becomes elected and is given certain rewards for validating the transaction and appending the transaction to the blockchain. Each computing node's mining power is limited by its specific computer architecture. For example, a computing node with a faster CPU clock rate has greater mining power compared to one with a slower clock rate.

As an example condition, for a block with some new transactions to be added to the blockchain, a nonce must be found such that when the nonce combined with other data in the block header and transaction list, and fed to the cryptographic hash function (e.g. SHA-256), the output string must begin with a certain number of leading “0s.” Since it is infeasible to recreate the data from its hash except by trying all possible inputs (property 3 of hash function), there only exists a brute force solution and it takes a very large number of trials to find the right nonce.

In some implementations, to become a validator node to participate in the mining process, a computer node is first ranked in the blockchain network based on a metric, and the computing node's probability to become a validator node is proportional to its rank in the blockchain network. For example, the metric can be a computing node's net possession of digital currency used in the blockchain network. Therefore, a computing node's probability to become a validator node is proportional to the amount of digital currency held by the computing node. A computing node that holds 1% of all available digital currency supported by the blockchain network has 1% chance of becoming a validator node. In another example, the metric can be a computing node's net transaction amount in a past time period.

In some implementations, a computer node becomes a validator node to participate in the mining process according to the example process illustrated in FIG. 3.

FIG. 3 is a flowchart of an example process for implementing a proof-of-devotion consensus algorithm in a blockchain network. The proof-of-devotion consensus algorithm uses a customized ranking of computer nodes in the blockchain network to select a group of validator nodes for proposing and validating new blocks.

The blockchain network selects the validator nodes using one or more ranking metrics. For example, the blockchain network can rank the computer nodes based on one or more of the amount of digital currency held by a computer node, the amount of digital currency outflowed from a computer node in a specified past time period, the amount of digital currency received by a computer node in a specified past time period, the number of other nodes transacting with a computer node in a specified past time period, etc. The blockchain network then selects the top N ranked computer nodes as the validator nodes, where N is number specified in the blockchain network.

Each validator node deposits a specified amount of digital currency to the blockchain network before participating in the mining process (302). The deposit may be returned back to the validator node depending on the result of the mining process.

The blockchain network next randomly selects a computer node from the group of validator nodes as a proposer node (304). The proposer node collects all transactions on the blockchain network since the last mining and packages the transactions into a proposed block as specified by the blockchain protocol (306). The proposer node then broadcasts the proposed block to the other validator nodes.

The validator nodes next participate in a voting scheme to validate the proposed block (308). In some implementations, the voting is a Byzantine-Fault-Tolerant-Style voting. The voting includes two rounds, a first round of prepare and a second round of commit. At the beginning of the first round, each validator node will release a specified amount of digital currency as a deposit, e.g., 2× where X is a number specified in the blockchain protocol. During the first round of voting, each validator node can either approve or reject the proposed block. An honest validator node, i.e., a validator node that votes truthfully, will look back into the transaction records on the blockchain to validate the proposed block. For example, if there is insufficient amount of digital currency to support a transaction, an honest validator node will reject the transaction. At the conclusion of the first round, if at least two-thirds of validator nodes approve the proposed block, the second round of voting will begin, and each validator node that approves the proposed block will recoup a specified amount of digital currency, e.g., 1.5×, after the conclusion of the second round. On the other hand, if more than one-third of validator nodes reject the proposed block, the voting process ends and the proposed block is not appended to the blockchain. Furthermore, in such a situation, none of the validator nodes will recoup any digital currency.

In the second round of voting, similar to the first round, each validator node can either approve or reject the proposed block (310). If at least two-thirds of validator nodes approve the proposed block, the proposed block is finalized and appended to the blockchain. Each of the validator nodes that approves the proposed block will receive an additional amount of digital currency (312), e.g., an additional 1.5×.

If the time lag between the first round and the second round exceeds a preset amount, the voting is considered expired and the proposed block is canceled.

Embodiments of the subject matter and the operations described in this document can be implemented in digital electronic circuitry, or in computer software, firmware, or hardware, including the structures, disclosed in this document and their structural equivalents, or in combinations of one or more of them. Embodiments of the subject matter described in this document can be implemented as one or more computer programs, i.e., one or more modules of computer program instructions encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
implementing a consensus process among a plurality of computing nodes in a blockchain network to add a block to a blockchain, wherein each computing node independently maintains a copy of a blockchain and communicates with other computing nodes according to a blockchain protocol, wherein implementing the consensus process comprises:
ranking the computing nodes according to a metric in a past time period;
designating a number of the top-ranked computing nodes as validator nodes;
selecting a validator node as a proposer node using a random process, wherein each validator node has a specified probability of being selected as the proposer node;
causing the proposer node to create a proposed block, wherein the proposed block comprises one or more transactions occurred on the blockchain;
causing each validator node to participate in a first round of voting on the proposed block, wherein each validator node deposits a first amount of digital currency before participating, and wherein each validator node votes an approval or a rejection of the proposed block;
in response to at least two-thirds of the validator nodes voting approval:
causing the validator nodes to participate in a second round of voting on the proposed block;
in response to at least two-thirds of the validator nodes voted approval in the second round of voting:
distributing to each validator node that voted approval in the first round of voting a second amount of digital currency;
distributing to each validator node that voted approval in the second round of voting a third amount of digital currency; and
adding the proposed block to the blockchain.

2. The method of claim 1, wherein the second amount and the third amount is each smaller than the first amount, and wherein the sum of the second amount and the third amount is greater than the first amount.

3. The method of claim 1, wherein a new group of validator nodes are selected for each new transaction.

4. The method of claim 1, further comprising distributing the deposits from the validator nodes that voted rejection in the first round equally to the validator nodes that voted approval in the first round of voting.

5. The method of claim 1, further comprising distributing the deposits from the validator nodes that voted rejection in the second round of voting equally to the validator nodes that voted approval in the second round of voting.

6. The method of claim 1, further comprising in response to more than one-third of validator nodes voting rejection to the transaction in the first or the second round of voting, dismissing the proposed block.

7. The method of claim 1, wherein the time period and the metric are specified in the blockchain protocol.

8. A system comprising one or more computers and one or more storage devices storing instructions that when executed by the one or more computers cause the one or more computers to perform operations comprising:
implementing a consensus process among a plurality of computing nodes in a blockchain network to add a block to a blockchain, wherein each computing node independently maintains a copy of a blockchain and communicates with other computing nodes according to a blockchain protocol, wherein implementing the consensus process comprises:
ranking the computing nodes according to a metric in a past time period;
designating a number of the top-ranked computing nodes as validator nodes;
selecting a validator node as a proposer node using a random process, wherein each validator node has a specified probability of being selected as the proposer node;
causing the proposer node to create a proposed block, wherein the proposed block comprises one or more transactions occurred on the blockchain;
causing each validator node to participate in a first round of voting on the proposed block, wherein each validator node deposits a first amount of digital currency before participating, and wherein each validator node votes an approval or a rejection of the proposed block;
in response to at least two-thirds of the validator nodes voting approval:
causing the validator nodes to participate in a second round of voting on the proposed block;
in response to at least two-thirds of the validator nodes voted approval in the second round of voting:
distributing to each validator node that voted approval in the first round of voting a second amount of digital currency;
distributing to each validator node that voted approval in the second round of voting a third amount of digital currency; and
adding the proposed block to the blockchain.

9. The system of claim 8, wherein the second amount and the third amount is each smaller than the first amount, and wherein the sum of the second amount and the third amount is greater than the first amount.

10. The system of claim 8, wherein a new group of validator nodes are selected for each new transaction.

11. The system of claim 8, further comprising distributing the deposits from the validator nodes that voted rejection in the first round equally to the validator nodes that voted approval in the first round of voting.

12. The system of claim 8, further comprising distributing the deposits from the validator nodes that voted rejection in the second round of voting equally to the validator nodes that voted approval in the second round of voting.

13. The system of claim 8, further comprising in response to more than one-third of validator nodes voting rejection to the transaction in the first or the second round of voting, dismissing the proposed block.

14. The system of claim 8, wherein the time period and the metric are specified in the blockchain protocol.

15. A non-transitory computer storage medium encoded with a computer program, the computer program storing instructions that when executed by one or more computers cause the one or more computers to perform operations comprising:
implementing a consensus process among a plurality of computing nodes in a blockchain network to add a block to a blockchain, wherein each computing node independently maintains a copy of a blockchain and communicates with other computing nodes according to a blockchain protocol, wherein implementing the consensus process comprises:
ranking the computing nodes according to a metric in a past time period;
designating a number of the top-ranked computing nodes as validator nodes;
selecting a validator node as a proposer node using a random process, wherein each validator node has a specified probability of being selected as the proposer node;
causing the proposer node to create a proposed block, wherein the proposed block comprises one or more transactions occurred on the blockchain;
causing each validator node to participate in a first round of voting on the proposed block, wherein each validator node deposits a first amount of digital currency before participating, and wherein each validator node votes an approval or a rejection of the proposed block;
in response to at least two-thirds of the validator nodes voting approval:
causing the validator nodes to participate in a second round of voting on the proposed block;
in response to at least two-thirds of the validator nodes voted approval in the second round of voting:
distributing to each validator node that voted approval in the first round of voting a second amount of digital currency;
distributing to each validator node that voted approval in the second round of voting a third amount of digital currency; and
adding the proposed block to the blockchain.

16. The non-transitory computer storage medium of claim 15, wherein the second amount and the third amount is each smaller than the first amount, and wherein the sum of the second amount and the third amount is greater than the first amount.

17. The non-transitory computer storage medium of claim 15, wherein a new group of validator nodes are selected for each new transaction.

18. The non-transitory computer storage medium of claim 15, further comprising distributing the deposits from the validator nodes that voted rejection in the first round equally to the validator nodes that voted approval in the first round of voting.

19. The non-transitory computer storage medium of claim 15, further comprising distributing the deposits from the validator nodes that voted rejection in the second round of voting equally to the validator nodes that voted approval in the second round of voting.

20. The non-transitory computer storage medium of claim 15, further comprising in response to more than one-third of validator nodes voting rejection to the transaction in the first or the second round of voting, dismissing the proposed block.
